(19) United States
(12) Patent Application Publication
(10) Pub. No.: US 2021/0201261 A1
(43) Pub. Date: Jul. 1, 2021

(54) AUTONOMOUS DELIVERY IDENTIFICATION, AUTHENTICATION, AND AUTHORIZATION

(71) Applicant: GM Cruise Holdings LLC, San Francisco, CA (US)

(72) Inventor: John Logan Anderson, San Francisco, CA (US)

(73) Assignee: GM Cruise Holdings LLC, San Francisco, CA (US)

(21) Appl. No.: 16/731,957

(22) Filed: Dec. 31, 2019

(51) Int. Cl. G06Q 10/08; G07C 9/25

(52) U.S. Cl. CPC G06Q 10/0836; G07C 9/257

(57) ABSTRACT

The present disclosure provides a method comprising using at least one first sensing device to identify an item disposed in a vehicle for delivery by the vehicle from an origin to a destination; performing at the destination an authentication process to authenticate a user who purports to be a recipient of the item, wherein the authentication process may be performed without human intervention; determining whether the authenticated user is an authorized recipient of the item, wherein the determining may be performed without human intervention; and automatically permitting the authorized recipient to retrieve the item from the vehicle.

### TECHNICAL FIELD OF THE DISCLOSURE

The present disclosure relates generally to use of autonomous vehicles (AVs) for making deliveries and, more specifically, to devices and methods for autonomous delivery identification, authentication, and authorization in connection with such autonomous vehicles.

### BACKGROUND

Fast, efficient, and safe transportation of a delivery from its point of origin to its destination may depend on a number of factors, including the characteristics of the delivery itself (which may include fragile, liquid, or sturdy, for example) and the condition of the road segments that make up the selected route (e.g., smooth, full of potholes, and/or riddled with speed bumps. When the delivery is made by an autonomous vehicle, there is no driver to ensure that the delivery is picked up, identified and authenticated as needed. Additionally, there is no driver to ensure that the delivery is accepted by an authorized recipient.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a block diagram illustrating an example autonomous vehicle in which an autonomous delivery identification, authentication, and authorization system according to some embodiments of the present disclosure may be implemented;

FIG. 2 is a block diagram illustrating an example autonomous delivery identification, authentication, and authorization system according to some embodiments of the present disclosure; and

FIG. 3 is a flowchart of an example method implemented by an example autonomous delivery identification, authentication, and authorization system according to some embodiments of the present disclosure.

### DESCRIPTION OF EXAMPLE EMBODIMENTS OF THE DISCLOSURE

The systems, methods and devices of this disclosure each have several innovative aspects, no single one of which is solely responsible for the all of the desirable attributes disclosed herein. Details of one or more implementations of the subject matter described in this specification are set forth in the description below and the accompanying drawings.

Embodiments of the present disclosure provide a method comprising using at least one first sensing device to identify an item disposed in a vehicle for delivery by the vehicle from an origin to a destination; performing at the destination an authentication process to authenticate a user who purports to be a recipient of the item, wherein the authentication process may be performed without human intervention; determining whether the authenticated user is an authorized recipient of the item, wherein the determining may be performed without human intervention; and automatically permitting the authorized recipient to retrieve the item from the vehicle.

Embodiments of the present disclosure further provide an autonomous delivery identification, authentication, and authorization system for a vehicle, the autonomous delivery identification, authentication, and authorization system at least one first sensing device to identify an item disposed in a vehicle for delivery by the vehicle from an origin to a destination; an authentication module for authenticating at the destination a user who purports to be a recipient of the item, wherein the authenticating may be performed without human intervention; and an authorization module for determining at the destination whether the authenticated user is an authorized recipient of the item, wherein an authenticated user who is also an authorized recipient is automatically access to retrieve the item from the vehicle.

Embodiments of the present disclosure still further provide an autonomous vehicle comprising an onboard computer; at least one first sensing device to identify an item disposed in a vehicle for delivery by the vehicle from an origin to a destination; an authentication module comprising at least one second sensing device for authenticating at the destination a user who purports to be a recipient of the item, wherein the authenticating may be performed without human intervention; and an authorization module comprising a data collection device for determining at the destination whether the authenticated user is an authorized recipient of the item, wherein the determining may be performed without human intervention, wherein an authenticated user who is also an authorized recipient is automatically access to retrieve the item from the vehicle.

Embodiments disclosed herein may be particularly advantageous for providing delivery identification, authentication, and authorization without requiring special packaging for the delivery. In certain embodiments, computer vision and sensors are used to perform those functions by a variety of means and in a variety of manners. As used herein “without human intervention” may be defined to mean “autonomously” or performed by a device capable of operating without direct human control.

As will be appreciated by one skilled in the art, aspects of the present disclosure, in particular aspects of an autonomous delivery identification, authentication, and authorization system for an autonomous vehicle, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g. one or more microprocessors, of one or more computers. In various embodiments, different steps and portions of the steps of each of the methods described herein may be performed by different processing units. Furthermore, aspects of the present disclosure may take the form of a computer program product embodied in one or more computer readable medium(s), preferably non-transitory, having computer readable program code embodied, e.g., stored, thereon. In various embodiments, such a computer program may, for example, be downloaded (updated) to the existing devices and systems (e.g. to the existing system devices and/or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims and/or select examples. In the following description, reference is made to the drawings in which like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

Other features and advantages of the disclosure will be apparent from the following description and the claims.

One embodiment is a system for autonomous vehicle delivery route selection based on delivery contents and mapping data. In particular, the system enables selection of one of a plurality of possible routes that will be taken by an autonomous vehicle to transport an item, or delivery, from an origin to a destination based on characteristics and/or an identity of the item being delivered and mapping data indicating a condition of various segments of the possible routes. Additionally, user and/or vehicle feedback may be provided during or after the delivery and may be used to update mapping data used in route selection. Moreover, additional constraints and considerations, such as cost, amount of fuel available or consumed, and/or amount of time to complete the delivery may also be considered in selecting one of the plurality of possible routes to be taken.

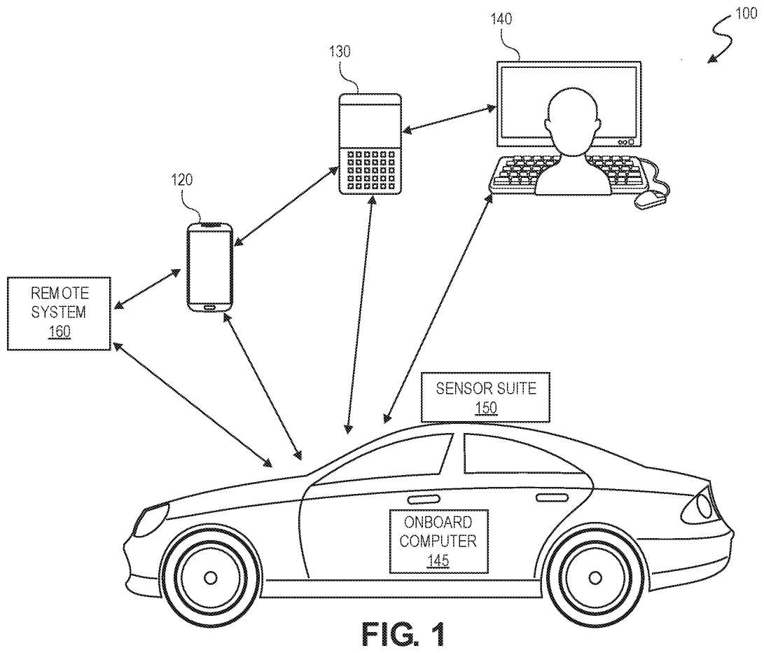

As shown in FIG. 1, an autonomous delivery identification, authentication, and authorization system 100 embodying features described herein includes an autonomous vehicle 110 including a passenger interface 120, a vehicle coordinator 130, and/or a remote expert interface 140. In certain embodiments, the remote expert interface 140 allows a non-passenger entity to set and/or modify the behavior settings of the autonomous vehicle 110. The non-passenger entity may be different from the vehicle coordinator 130, which may be a server.

A remote facility 160, which may comprise a central office or backoffice facility, may also be provided for providing the autonomous vehicle 110 (and particularly, the onboard computer 145) with a number of different system backend functions. The remote facility 160 may include one or more switches, servers, databases, live advisors, and/or an automated voice response system (“VRS”). Remote facility 160 may include any or all of the aforementioned components, which may be coupled to one another via a wired or wireless local area network (LAN). Remote facility 160 may receive and transmit data via one or more appropriate devices and network from and to the autonomous vehicle 110, such as by wireless systems, such as 882.11x, GPRS, and the like. A database at the remote facility 160 can store account information such as subscriber authentication information, vehicle identifiers, profile records, behavioral patterns, and other pertinent subscriber information. The remote facility 160 may also include a database of roads, routes, locations, etc. permitted for use by autonomous vehicle 110. The remote facility 160 may communicate with the autonomous vehicle 110 to provide route guidance in response to a request received from the vehicle.

For example, based upon information stored in a mapping system of the remote facility 160, the remote facility may determine the conditions of various roads or portions thereof. Autonomous vehicles, such as the autonomous vehicle 110, may, in the course of determining a navigation route, receive instructions from the remote facility 160 regarding which roads or portions thereof, if any, are appropriate for use under certain circumstances, as described hereinbelow. Such instructions may be based in part on information received from the autonomous vehicle 110 or other autonomous vehicles regarding road conditions Accordingly, remote facility 160 may receive information regarding the roads/routes generally in real-time from one or more vehicles.

The system 100 functions to enable an autonomous vehicle 110 to modify and/or set a driving behavior in response to parameters set by vehicle passengers (e.g., via the passenger interface 120) and/or other interested parties (e.g., via the vehicle coordinator 130 or remote expert interface 140). In accordance with features of embodiments described herein, the system 100 further functions to enable autonomous vehicle 110 to modify and/or set a driving behavior and/or route automatically in response to delivery contents or other considerations or factors. Driving behavior of an autonomous vehicle may be modified according to explicit input or feedback (e.g., a passenger specifying a maximum speed or a relative comfort level), implicit input or feedback (e.g., a passenger's heart rate), or any other suitable data or manner of communicating driving behavior preferences.

The autonomous vehicle 110 is preferably a fully autonomous automobile, but may additionally or alternatively be any semi-autonomous or fully autonomous vehicle; e.g., a boat, an unmanned aerial vehicle, a driverless car, etc. Additionally, or alternatively, the autonomous vehicles may be vehicles that switch between a semi-autonomous state and a fully autonomous state and thus, some autonomous vehicles may have attributes of both a semi-autonomous vehicle and a fully autonomous vehicle depending on the state of the vehicle.

The autonomous vehicle 110 preferably includes a throttle interface that controls an engine throttle, motor speed (e.g., rotational speed of electric motor), or any other movement-enabling mechanism; a brake interface that controls brakes of the autonomous vehicle (or any other movement-retarding mechanism); and a steering interface that controls steering of the autonomous vehicle (e.g., by changing the angle of wheels of the autonomous vehicle). The autonomous vehicle 110 may additionally or alternatively include interfaces for control of any other vehicle functions; e.g., windshield wipers, headlights, turn indicators, air conditioning, etc.

In addition, the autonomous vehicle 110 preferably includes an onboard computer 145 and a sensor suite 150 (e.g., computer vision (“CV”) system, LIDAR, RADAR, wheel speed sensors, GPS, cameras, etc.). The onboard computer 145 functions to control the autonomous vehicle 110 and processes sensed data from the sensor suite 150 and/or other sensors in order to determine the state of the autonomous vehicle 110. Based upon the vehicle state and programmed instructions, the onboard computer 145 preferably modifies or controls driving behavior of the autonomous vehicle 110.

Driving behavior may include any information relating to how an autonomous vehicle drives (e.g., actuates brakes, accelerator, steering) given a set of instructions (e.g., a route or plan). Driving behavior may include a description of a controlled operation and movement of an autonomous vehicle and the manner in which the autonomous vehicle applies traffic rules during one or more driving sessions. Driving behavior may additionally or alternatively include any information about how an autonomous vehicle calculates routes (e.g., prioritizing fastest time vs. shortest distance), other autonomous vehicle actuation behavior (e.g., actuation of lights, windshield wipers, traction control settings, etc.) and/or how an autonomous vehicle responds to environmental stimulus (e.g., how an autonomous vehicle behaves if it is raining, or if an animal jumps in front of the vehicle). Some examples of elements that may contribute to driving behavior include acceleration constraints, deceleration constraints, speed constraints, steering constraints, suspension settings, routing preferences (e.g., scenic routes, faster routes, no highways), lighting preferences, “legal ambiguity” conduct (e.g., in a solid-green left turn situation, whether a vehicle pulls out into the intersection or waits at the intersection line), action profiles (e.g., how a vehicle turns, changes lanes, or performs a driving maneuver), and action frequency constraints (e.g., how often a vehicle changes lanes).

The onboard computer 145 functions to control the operations and functionality of the autonomous vehicles 110 and processes sensed data from the sensor suite 150 and/or other sensors in order to determine states of the autonomous vehicles no. Based upon the vehicle state and programmed instructions, the onboard computer 145 preferably modifies or controls behavior of autonomous vehicles 110. The onboard computer 145 is preferably a general-purpose computer adapted for I/O communication with vehicle control systems and sensor systems, but may additionally or alternatively be any suitable computing device. The onboard computer 145 is preferably connected to the Internet via a wireless connection (e.g., via a cellular data connection). Additionally or alternatively, the onboard computer 145 may be coupled to any number of wireless or wired communication systems.

The sensor suite 150 preferably includes localization and driving sensors; e.g., photodetectors, cameras, RADAR, SONAR, LIDAR, GPS, inertial measurement units (IMUS), accelerometers, microphones, strain gauges, pressure monitors, barometers, thermometers, altimeters, etc.

In certain embodiments, information collected by autonomous vehicles, such as autonomous vehicle 110, may be provided to the remote facility 160, which may establish a database or map of routes in a given area or region where use of an autonomous driving system may be permitted. Information may be collected from vehicles in real-time, i.e., as the vehicle(s) traverses the route(s) in question. Information may be analyzed by a central office of the remote facility 160 in real-time, or on a periodic basis. The information may be provided to vehicles collectively in the area, e.g., by way of a central database or map. For example, vehicles may pull route information from the database/map to determine appropriate route(s) for use of an autonomous driving system in any manner that is convenient. In some examples, a vehicle telematics unit may selectively communicate with the remote facility to determine whether a route may be used with an autonomous driving system. In accordance with another aspect of the invention, there is provided a system for communicating with a plurality of vehicles may include a plurality of telematics units installed into each of the vehicles. The telematics units are configured to collect route information as the vehicles are traveling along a vehicle route.

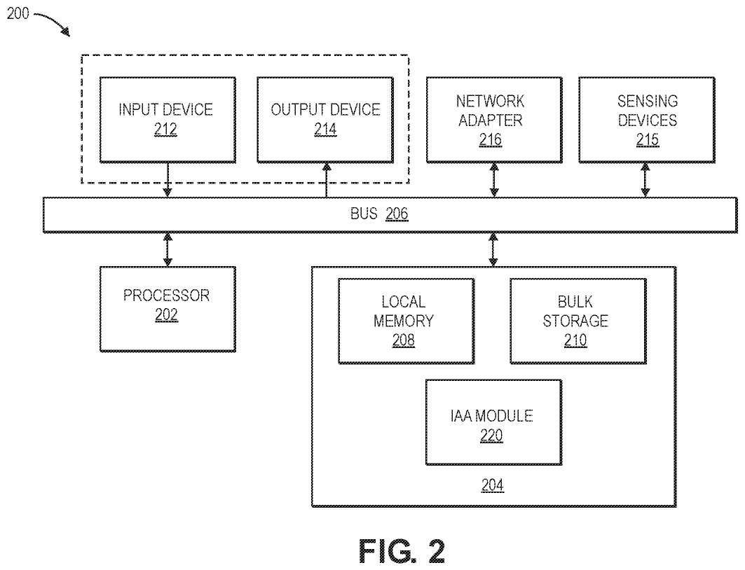

FIG. 2 is a block diagram illustrating an example system 200 that may be configured to implement at least portions of an autonomous delivery identification, authentication, and authorization system for an autonomous vehicle, such as the autonomous vehicle 110, in accordance with embodiments described herein, and more particularly as shown in the FIGURES described hereinabove. Part or all of the autonomous delivery identification, authentication, and authorization system 200 may be implemented as a sensor suite, such as the sensor suite 150, and/or an onboard computer, such as onboard computer 145, and/or a remote system, such as remote facility 160. As shown in FIG. 2, the autonomous delivery identification, authentication, and authorization system 200 may include at least one processor 202, e.g. a hardware processor 202, coupled to memory elements 204 through a system bus 206. As such, the system may store program code and/or data within memory elements 204. Further, the processor 202 may execute the program code accessed from the memory elements 204 via a system bus 206. In one aspect, the system may be implemented as a computer that is suitable for storing and/or executing program code (e.g., onboard computer 145). It should be appreciated, however, that the system 200 may be implemented in the form of any system including a processor and a memory that is capable of performing the functions described in this disclosure.

In some embodiments, the processor 202 can execute software or an algorithm to perform the activities as discussed in this specification; in particular, activities related to an autonomous delivery identification, authentication, and authorization system for an autonomous vehicle in accordance with embodiments described herein. The processor 202 may include any combination of hardware, software, or firmware providing programmable logic, including by way of non-limiting example a microprocessor, a DSP, a field-programmable gate array (FPGA), a programmable logic array (PLA), an integrated circuit (IC), an application specific IC (ASIC), or a virtual machine processor. The processor 202 may be communicatively coupled to the memory element 204, for example in a direct-memory access (DMA) configuration, so that the processor 202 may read from or write to the memory elements 204.

In general, the memory elements 204 may include any suitable volatile or non-volatile memory technology, including double data rate (DDR) random access memory (RAM), synchronous RAM (SRAM), dynamic RAM (DRAM), flash, read-only memory (ROM), optical media, virtual memory regions, magnetic or tape memory, or any other suitable technology. Unless specified otherwise, any of the memory elements discussed herein should be construed as being encompassed within the broad term “memory.” The information being measured, processed, tracked or sent to or from any of the components of the system 200 could be provided in any database, register, control list, cache, or storage structure, all of which can be referenced at any suitable timeframe. Any such storage options may be included within the broad term “memory” as used herein. Similarly, any of the potential processing elements, modules, and machines described herein should be construed as being encompassed within the broad term “processor.” Each of the elements shown in the present figures may also include suitable interfaces for receiving, transmitting, and/or otherwise communicating data or information in a network environment so that they can communicate with, for example, a system having hardware similar or identical to another one of these elements.

In certain example implementations, mechanisms for implementing an autonomous delivery identification, authentication, and authorization system for an autonomous vehicle as outlined herein may be implemented by logic encoded in one or more tangible media, which may be inclusive of non-transitory media, e.g., embedded logic provided in an ASIC, in DSP instructions, software (potentially inclusive of object code and source code) to be executed by a processor, or other similar machine, etc. In some of these instances, memory elements, such as e.g. the memory elements 204 shown in FIG. 2, can store data or information used for the operations described herein. This includes the memory elements being able to store software, logic, code, or processor instructions that are executed to carry out the activities described herein. A processor can execute any type of instructions associated with the data or information to achieve the operations detailed herein. In one example, the processors, such as e.g. the processor 202 shown in FIG. 2, could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., an FPGA, a DSP, an erasable programmable read-only memory (EPROM), an electrically erasable programmable read-only memory (EEPROM)) or an ASIC that includes digital logic, software, code, electronic instructions, or any suitable combination thereof.

The memory elements 204 may include one or more physical memory devices such as, for example, local memory 208 and one or more bulk storage devices 210. The local memory may refer to RAM or other non-persistent memory device(s) generally used during actual execution of the program code. A bulk storage device may be implemented as a hard drive or other persistent data storage device. The processing system 200 may also include one or more cache memories (not shown) that provide temporary storage of at least some program code in order to reduce the number of times program code must be retrieved from the bulk storage device 210 during execution.

As shown in FIG. 2, the memory elements 204 may store a delivery identification, authentication, and authorization (“IAA”) module 220. In various embodiments, the IAA module 220 may be implemented as one or more modules stored in the local memory 208, the one or more bulk storage devices 210, or apart from the local memory and the bulk storage devices. It should be appreciated that the system 200 may further execute an operating system (not shown in FIG. 2) that can facilitate execution of the module 220. The module 220, being implemented in the for 2 m of executable program code and/or data, can be read from, written to, and/or executed by the system 200, e.g., by the processor 202. Responsive to reading from, writing to, and/or executing the module 220, the system 200 may be configured to perform one or more operations or method steps described herein.

Input/output (I/O) devices depicted as an input device 212 and an output device 214, optionally, may be coupled to the system. Examples of input devices may include, but are not limited to, a keyboard, a pointing device such as a mouse, or the like. Examples of output devices may include, but are not limited to, a monitor or a display, speakers, or the like. In some implementations, the system may include a device driver (not shown) for the output device 214. Input and/or output devices 212, 214 may be coupled to the system 200 either directly or through intervening I/O controllers. Additionally, sensing devices 215, may be coupled to the system 200. Examples of sensing devices 215 may include, but are not limited to, cameras (located inside and/or outside the vehicle), computer vision (“CV”) system, LIDAR, RADAR, wheel speed sensors, GPS, and others. Sensing devices 215 may be coupled to the system 200 either directly or through intervening controllers and/or drivers.

Cameras may be implemented using high-resolution imagers with fixed mounting and field of view. LIDARs may be implemented using scanning LIDARs with dynamically configurable field of view that provides a point-cloud of the region intended to scan. RADARs may be implemented using scanning RADARs with dynamically configurable field of view.

In an embodiment, the input and the output devices may be implemented as a combined input/output device (illustrated in FIG. 2 with a dashed line surrounding the input device 212 and the output device 214). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 216 may also, optionally, be coupled to the system 200 to enable it to become coupled to other systems, computer systems, remote network devices, and/or remote storage devices through intervening private or public networks. The network adapter may comprise a data receiver for receiving data that is transmitted by said systems, devices and/or networks to the system 200, and a data transmitter for transmitting data from the system 200 to said systems, devices and/or networks. Modems, cable modems, and Ethernet cards are examples of different types of network adapter that may be used with the system 200.

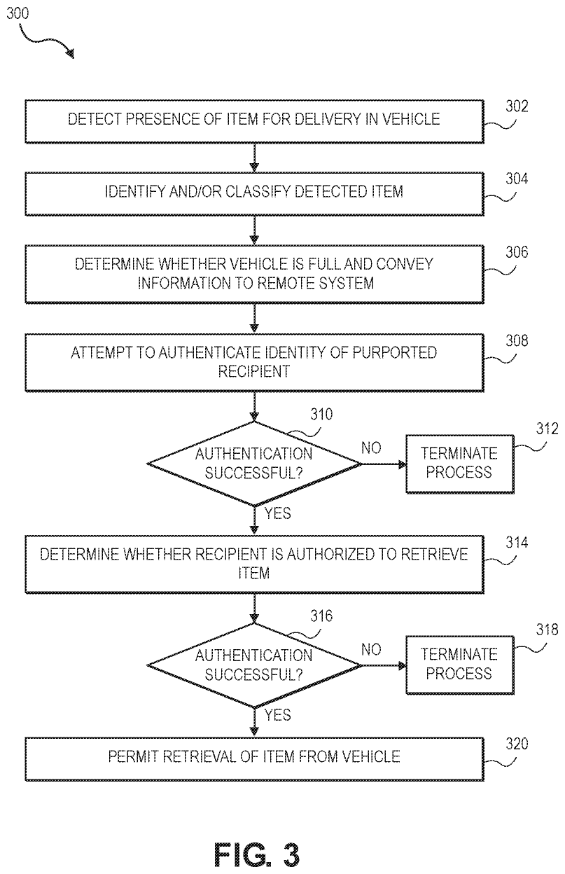

FIG. 3 is a flowchart of an example method 300 implemented by an autonomous delivery identification, authentication, and authorization system according to some embodiments of the present disclosure, such as the autonomous delivery identification, authentication, and authorization system 200 of FIG. 2. In some embodiments, executable instructions for causing a processor to perform the method 300 are stored in the module 220. In step 302, one or more sensors are used to detect the presence of an item in the vehicle. For example, a tire pressure or weight sensor or a vehicle seat occupancy sensor, may be used to detect the presence of an item in the vehicle. In step 304, one or more sensors are used to identify and/or classify an item received for delivery. For example, in step 304, a determination may be made whether the received item is groceries, for example, as opposed to a package. In some embodiments, this information may be stored in a database locally and/or provided to a remote system for use in controlling the operation of the vehicle. It will be recognized that this step may be performed in any number of manners. For example, a picture or scan of the item for delivery may have been previously provided to the system, such that identification and/or characterization of the item may be performed by using computer vision to compare the received item to the picture or scan. Alternatively, a vision-based scanner (imager) maybe used to detect, identify and/or characterize one or more items received in the autonomous delivery vehicle. Still further, in certain systems (e.g., those in which a limited number of items are to be delivered using the autonomous delivery system), detection systems discussed above in connection with step 301 may be used to sense a weight of the item and thereby determine an identity of the item (e.g., by determining which item of a list of items weighs the detected amount).

In an optional step 306, a determination may be made based on the information gleaned in step 302 whether the vehicle is “full” or has capacity to receive additional items before delivering the items it has already received. For example, if the item currently in the vehicle is a large item that that occupies the entire delivery compartment of the vehicle, then no additional items can be picked up before the current item is delivered. In contrast, if the item currently in the vehicle is a small item that occupies only a portion of the delivery compartment of the vehicle, an additional small item may be included in the vehicle prior to delivery of the current item. This information may be conveyed to a remote system, for example, which may schedule additional delivery pick up stops for the vehicle prior to delivery of the any of the items.

In step 308, upon reaching the delivery destination, the autonomous delivery identification, authentication, and authorization system attempts to authenticate the identity of the purported recipient. For example, the identity of the purported recipient may be authenticated using computer vision or a camera to determine whether the purported recipient matches one of a plurality of images associated with persons “known” by the system. Alternatively, the purported recipient may be required to provide documentation of his or her identity, such as by inserting a personal identification card (such as a driver's license or credit card, for example) into an appropriate card reader provided on the exterior of the vehicle or scanning information provided on identity documents (such as a bar code on a passport, for example) using an appropriate scanner. In step 310, a determination is made whether authentication was successful. If not, execution terminates in step 312 and the delivery may be returned to the origin, for example. In contrast, if the identity of the purported recipient is confirmed, execution proceeds to step 314.

In step 314, the autonomous delivery identification, authentication, and authorization system determines whether the authenticated recipient is authorized to retrieve the delivery from the vehicle. This step may be performed, for example, by the recipient's scanning a machine-readable code, such as a QR code or bar code, previously provided to the recipient (e.g., via email or text) using an appropriate code scanner provided on the exterior of the vehicle. Additionally and/or alternatively, the recipient may be required to enter a code, or password, previously provided to the recipient (e.g., via text or email) using a keypad or other input device disposed on the exterior of the vehicle in order. In step 316, a determination is made whether authorization was successful. If not, execution terminates in step 318 and the delivery may be returned to the origin, for example. It will be recognized that the recipient may be given multiple opportunities to present authorization data before the authorization step is deemed unsuccessful. If the authorization step is successful, in step 320, the recipient is granted access to the item in the delivery compartment.

In certain embodiments, the vehicle may contain multiple delivery compartments, in which case, the authorization step may correspond to a particular delivery compartment (of which the recipient has been notified, for example, by text or email), such that the user is authorized to open only that compartment to retrieve the item.

Example 1 is a method comprising using at least one first sensing device to identify an item disposed in a vehicle for delivery by the vehicle from an origin to a destination; performing at the destination an authentication process to authenticate a user who purports to be a recipient of the item, wherein the authentication process may be performed without human intervention; determining whether the authenticated user is an authorized recipient of the item, wherein the determining may be performed without human intervention; and automatically permitting the authorized recipient to retrieve the item from the vehicle.

In Example 2, the method of Example 1 may further include the at least one first sensing device comprising computer vision.

In Example 3, the method of any of Examples 1-2 may further include using at least one second sensing device to detect that the item has been placed in the vehicle, wherein the at least one second sensing device comprises at least one of a tire pressure sensor, a camera, computer vision, a seat occupancy sensor, and a weight sensor device.

In Example 4, the method of any of Examples 1-3 may further include the performing at the destination an authentication process comprising using a second sensing device to read identification information from documentation presented to the second sensing device by the user.

In Example 5, the method of Example 4 may further include the second sensing device comprising a card reader and the documentation comprises at least one of a credit card and a driver's license.

In Example 6, the method of Example 4 may further include the second sensing device comprising a code reader and the documentation comprises a passport.

In Example 7, the method of any of Examples 1-6 may further include the performing at the destination an authentication process comprising using at least one camera to capture an image of the user, wherein the picture of the user is compared with a stored image corresponding to a known person.

In Example 8, the method of any of Examples 1-7 may further include returning the vehicle containing the item to the origin if at least one of the authentication or the authorization is deemed a failure.

In Example 9, the method of any of Examples 1-8 may further include the determining further comprising using a keypad disposed on an exterior surface of the vehicle to receive an authorization code entered by the user.

In Example 10, the method of any of Examples 1-9 may further include the determining further comprising using a code reader disposed on an exterior surface of the vehicle to read a machine-readable code presented by the user.

In Example 11, the method of any of Examples 1-10 may further include the vehicle comprising an autonomous vehicle.

In Example 12, the method of any of Examples 1-11 may further include the item being disposed in a delivery compartment of the vehicle.

In Example 13, the method of Example 12 may further include the delivery compartment comprising multiple delivery compartments.

In Example 14, an autonomous delivery identification, authentication, and authorization system for a vehicle may include at least one first sensing device to identify an item disposed in a vehicle for delivery by the vehicle from an origin to a destination; an authentication system for authenticating at the destination a user who purports to be a recipient of the item, wherein the authenticating may be performed without human intervention; and an authorization system for determining at the destination whether the authenticated user is an authorized recipient of the item, wherein the determining may be performed without human intervention, wherein an authenticated user who is also an authorized recipient is automatically access to retrieve the item from the vehicle.

In Example 15, the autonomous delivery identification, authentication, and authorization system of Example 14 may further include at least one second sensing device for detecting the item has been placed in the vehicle, wherein the at least one second sensing device comprises at least one of a tire pressure sensing device, a camera, computer vision, a seat occupancy sensing device, and a weight sensing device.

In Example 16, the autonomous delivery identification, authentication, and authorization system of any of Examples 14-15 may further include the authentication system comprising a second sensing device for reading identification information from documentation presented to the second sensing device by the user.

In Example 17, the autonomous delivery identification, authentication, and authorization system of any of Examples 14-16 may further include the authentication system comprising at least one camera for capturing an image of the user, wherein the picture of the user is compared with a stored image corresponding to a known person.

In Example 18, the autonomous delivery identification, authentication, and authorization system of any of Examples 14-17 may further include the authorization system comprising a keypad disposed on an exterior surface of the vehicle for receiving an authorization code entered by the user.

In Example 19, the autonomous delivery identification, authentication, and authorization system of any of Examples 14-18 may further include the authorization system further comprising a code reader disposed on an exterior surface of the vehicle for reading a machine-readable code presented by the user.

In Example 20, an autonomous vehicle may include an onboard computer; at least one first sensing device to identify an item disposed in a vehicle for delivery by the vehicle from an origin to a destination; an authentication module comprising at least one second sensing device for authenticating at the destination a user who purports to be a recipient of the item, wherein the authenticating may be performed without human intervention; and an authorization module comprising a data collection device for determining at the destination whether the authenticated user is an authorized recipient of the item, wherein the determining may be performed without human intervention, wherein an authenticated user who is also an authorized recipient is automatically access to retrieve the item from the vehicle.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the FIGS. may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

In another example embodiment, the electrical circuits of the FIGS. may be implemented as stand-alone modules (e.g., a device with associated components and circuitry configured to perform a specific application or function) or implemented as plug-in modules into application specific hardware of electronic devices. Note that particular embodiments of the present disclosure may be readily included in a system on chip (SOC) package, either in part, or in whole. An SOC represents an IC that integrates components of a computer or other electronic system into a single chip. It may contain digital, analog, mixed-signal, and often radio frequency functions: all of which may be provided on a single chip substrate. Other embodiments may include a multi-chip-module (MCM), with a plurality of separate ICs located within a single electronic package and configured to interact closely with each other through the electronic package. In various other embodiments, the digital filters may be implemented in one or more silicon cores in Application Specific Integrated Circuits (ASICs), Field Programmable Gate Arrays (FPGAs), and other semiconductor chips.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular arrangements of components. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the FIGS. may be combined in various possible configurations, all of which are clearly within the broad scope of this Specification. In certain cases, it may be easier to describe one or more of the functionalities of a given set of flows by only referencing a limited number of electrical elements. It should be appreciated that the electrical circuits of the FIGS. and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

It is also important to note that the functions related to contactless current measurement using magnetic sensors, e.g. those summarized in the one or more processes shown in FIGS., illustrate only some of the possible functions that may be executed by, or within, the current measurement systems illustrated in the FIGS. Some of these operations may be deleted or removed where appropriate, or these operations may be modified or changed considerably without departing from the scope of the present disclosure. In addition, the timing of these operations may be altered considerably. The preceding operational flows have been offered for purposes of example and discussion. Substantial flexibility is provided by embodiments described herein in that any suitable arrangements, chronologies, configurations, and timing mechanisms may be provided without departing from the teachings of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the apparatus described above may also be implemented with respect to the method or process described herein and specifics in the examples may be used anywhere in one or more embodiments.

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. Section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

What is claimed is:

1. A method comprising:
using at least one first sensing device to identify an item disposed in a vehicle for delivery by the vehicle from an origin to a destination;
performing at the destination an authentication process to authenticate a user who purports to be a recipient of the item, wherein the authentication process is performed without human intervention;
determining whether the authenticated user is an authorized recipient of the item, wherein the determining is performed without human intervention; and
automatically permitting the authorized recipient to retrieve the item from the vehicle.

2. The method of claim 1, wherein the at least one first sensing device comprises computer vision.

3. The method of claim 1 further comprising:
using at least one second sensing device to detect that the item has been placed in the vehicle, wherein the at least one second sensing device comprises at least one of a tire pressure sensor, a camera, computer vision, a seat occupancy sensor, and a weight sensor device.

4. The method of claim 1, wherein the performing at the destination an authentication process comprises using a second sensing device to read identification information from documentation presented to the second sensing device by the user.

5. The method of claim 4, wherein the second sensing device comprises a card reader and the documentation comprises at least one of a credit card and a driver's license.

6. The method of claim 4, wherein the second sensing device comprises a code reader and the documentation comprises a passport.

7. The method of claim 1, wherein the performing at the destination an authentication process comprises using at least one camera to capture an image of the user, wherein the picture of the user is compared with a stored image corresponding to a known person.

8. The method of claim 1 further comprising returning the vehicle containing the item to the origin if at least one of the authentication or the authorization is deemed a failure.

9. The method of claim 1, wherein the determining further comprises using a keypad disposed on an exterior surface of the vehicle to receive an authorization code entered by the user.

10. The method of claim 1, wherein the determining further comprises using a code reader disposed on an exterior surface of the vehicle to read a machine-readable code presented by the user.

11. The method of claim 1, wherein the vehicle is an autonomous vehicle.

12. The method of claim 1, wherein the item is disposed in a delivery compartment of the vehicle.

13. The method of claim 12, wherein the delivery compartment comprises multiple delivery compartments.

14. An autonomous delivery identification, authentication, and authorization system for a vehicle, the autonomous delivery identification, authentication, and authorization system comprising:
at least one first sensing device to identify an item disposed in a vehicle for delivery by the vehicle from an origin to a destination;
an authentication system for authenticating at the destination a user who purports to be a recipient of the item, wherein the authenticating is performed without human intervention; and
an authorization system for determining at the destination whether the authenticated user is an authorized recipient of the item, wherein the determining is performed without human intervention;
wherein an authenticated user who is also an authorized recipient is automatically access to retrieve the item from the vehicle.

15. The autonomous delivery identification, authentication, and authorization system of claim 14 further comprising:
at least one second sensing device for detecting the item has been placed in the vehicle, wherein the at least one second sensing device comprises at least one of a tire pressure sensing device, a camera, computer vision, a seat occupancy sensing device, and a weight sensing device.

16. The autonomous delivery identification, authentication, and authorization system of claim 14, wherein the authentication system comprises a second sensing device for reading identification information from documentation presented to the second sensing device by the user.

17. The autonomous delivery identification, authentication, and authorization system of claim 14, wherein the authentication system comprises at least one camera for capturing an image of the user, wherein the picture of the user is compared with a stored image corresponding to a known person.

18. The autonomous delivery identification, authentication, and authorization system of claim 14, wherein the authorization system comprises a keypad disposed on an exterior surface of the vehicle for receiving an authorization code entered by the user.

19. The autonomous delivery identification, authentication, and authorization system of claim 14, wherein the authorization system further comprises a code reader disposed on an exterior surface of the vehicle for reading a machine-readable code presented by the user.

20. An autonomous vehicle comprising:
an onboard computer;
at least one first sensing device to identify an item disposed in a vehicle for delivery by the vehicle from an origin to a destination;
an authentication module comprising at least one second sensing device for authenticating at the destination a user who purports to be a recipient of the item, wherein the authenticating is performed without human intervention; and
an authorization module comprising a data collection device for determining at the destination whether the authenticated user is an authorized recipient of the item, wherein the determining is performed without human intervention;
wherein an authenticated user who is also an authorized recipient is automatically access to retrieve the item from the vehicle.
